(19) United States
(12) Patent Application Publication
(10) Pub. No.: US 2019/0018106 A1
(43) Pub. Date: Jan. 17, 2019

(54) Light-Source Array for a Time-of-Flight Sensor and Method of Operation of Same

(71) Applicant: 4Sense, Inc., Delray Beach, FL (US)

(72) Inventor: Stanislaw K. Skowronek, New York, NY (US)

(73) Assignee: 4Sense, Inc., Delray Beach, FL (US)

(21) Appl. No.: 15/646,969

(22) Filed: Jul. 11, 2017

(51) Int. Cl. G01S 7/484; G01S 17/10; G01S 17/66; G01S 7/48; G01S 17/02; G01S 17/42; G01S 7/481

(52) U.S. Cl. CPC G01S 7/484; G01S 17/10; G01S 17/66; G01S 7/4815; G01S 17/023; G01S 17/42; G01S 7/4802

(57) ABSTRACT

A system and method for reducing the effects of multipath propagation (MPP) arising from the operation of a time-of-flight (ToF) sensor are described. The ToF sensor can include light sources that emit modulated light in a monitoring area, which may be partitioned into a number of segments. The light sources may correspond to the segments. Tracking data of an object in the area can be analyzed to determine which segments are occupied by the object. The light sources corresponding to segments occupied by the object can be activated, and the light sources corresponding to segments unoccupied by the object can be deactivated. Modulated light may be emitted from only the activated light sources. Reflections of the modulated light from the object can be received and based on the received reflections, a depth distance of the object with respect to the ToF sensor can be provided.

### FIELD

The subject matter described herein relates to time-of-flight (ToF) sensors and more particularly, to systems for controlling the illumination of the ToF sensors.

### BACKGROUND

Several companies develop and manufacture ToF sensors, which are designed to illuminate an area with light, typically in the near-infrared range of the light spectrum, that has been modulated with an input signal and to capture reflections of the modulated light from objects in the area. The ToF sensor may detect phase shifts of the input signal modulating the light and may translate these differences into distances between the ToF sensor and the objects.

In accordance with its operation, a ToF sensor will flood the area with the modulated light, which may produce reflections of the light from many different objects, including objects that are desired or intended targets and those that are not. If the area in which the ToF sensor is situated is a typical working or living environment, the light will be reflected from many objects that are not intended targets, such as floors, walls, ceilings, furniture, and office equipment. An excessive number of reflections from such objects leads to multipath propagation (MPP). For example, as an intended target in the area moves farther away from the ToF sensor, the reflections of light off the intended target are corrupted with reflections from the objects that are not intended targets. In some cases, the reflections from the intended target and the other objects that are not intended targets may add up or even cancel each other out, such as if the modulating input signals are 180 degrees out of phase. In either case, the quality of the data provided by the ToF sensor will suffer.

Other problems may arise from MPP. For example, light that is reflected from a nearby object is scattered into the optical system (including the lens or sensor itself) and is mixed into the light reflected from an object that is relatively far away. This scattered light may be intense enough to degrade the dynamic range of the more distant object. Traditional high-dynamic range (HDR) techniques, which allow objects of very disparate intensities to coexist in a scene, are not viable solutions to this problem because the light from the two objects is mixed. In particular, HDR techniques work by changing gain or integration time, such as using higher gain and longer integration data for the far-away objects. If the light from the nearby object is scattered and mixed into the weaker light from the more distant object and is more intense than that of the distant object, using longer integration will proportionally increase its contribution (in addition to that of the distant object), offering no improvement. Further compounding the effects of MPP, electrical crosstalk (or unintended interference between signals) inside the sensor may cause information associated with the nearby object to be mixed with that of the object that is farther away.

### SUMMARY

A time-of-flight (ToF) sensor for reducing multipath propagation (MPP) is described herein. The ToF sensor can include a controller, processor, and plurality of light sources configured to emit modulated light in a monitoring area, and the light sources may have predetermined orientations. The controller can be communicatively coupled to the light sources and can be configured to activate and deactivate the light sources. The processor can be communicatively coupled to the controller and can be configured to receive tracking data from one or more sensors of a passive-tracking system in which the tracking data can identify a location of a first object in the monitoring area being passively tracked by the passive-tracking system. The processor can also be configured to signal the controller to selectively activate and deactivate the light sources based on the tracking data such that one or more of the light sources with orientations that align with the location of the first object may be activated and one or more of the light sources that are out of alignment with the location of the first object may be deactivated.

In one embodiment, the plurality of light sources may be part of an array of light sources, and the predetermined orientations of the light sources may be fixed. The processor may be further configured to determine a depth distance of the first object with respect to the ToF sensor based on reflections of the modulated light from the first object. In another embodiment, the controller may be further configured to activate the light sources by switching the light sources on or by maintaining power to the light sources and to deactivate the light sources by switching the light sources off or by maintaining the light sources in an off state.

The monitoring area may be partitioned into a predetermined number of segments, and the predetermined number of segments may be equal to the number of light sources such that each light source corresponds to a segment. Moreover, the tracking data may indicate that the first object occupies one or more of the segments of the monitoring area. The processor may be further configured to, in such a case, signal the controller to selectively activate the light sources based on the tracking data such that one or more of the light sources with orientations that align with the location of the first object are activated by activating the light sources that correspond to the segments occupied by the first object. The tracking data may also indicate that the first object does not occupy one or more of the segments of the monitoring area. The processor can be further configured to, in this scenario, signal the controller to selectively deactivate the light sources based on the tracking data such that one or more of the light sources with orientations that are out of alignment with the location of the first object are deactivated by deactivating the light sources that correspond to the segments that are not occupied by the first object.

In one arrangement, the ToF sensor may include a plurality of optical elements in which each optical element may be paired with one of the light sources. As an example, the optical elements may be diffusers that diffuse the modulated light from the light sources or may be lenses that project the modulated light from the light sources. In another arrangement, the ToF sensor may include a shared optical element that can be paired with each of the light sources. In this example, the shared optical element may be a diffuser that diffuses the modulated light from the light sources or may be a lens that projects the modulated light from the light sources.

The tracking data may also identify a new location of the first object based on movement by the first object in the monitoring area. The processor can be further configured to, in such a case, signal the controller to selectively activate and deactivate the light sources based on the tracking data such that one or more of the light sources with orientations that align with the new location of the first object are activated and one or more of the light sources with orientations that are out of alignment with the new location of the first object are deactivated. In another example, the tracking data may also identify a location of a second object in the monitoring area being passively tracked by the passive tracking system at the same time as the first object. The processor may be further configured to, in this example, signal the controller to selectively activate and deactivate the light sources based on the tracking data such that one or more of the light sources with orientations that align with the locations of both the first and second objects may be activated and one or more of the light sources with orientations that are out of alignment with the locations of both the first and second objects may be deactivated.

A method for reducing MPP is also described herein. The method can include the steps of determining that a first object is present in a monitoring area and in response to determining that the first object is present, passively tracking the first object. Passively tracking the first object can include the steps of determining a location of the first object in the monitoring area and controlling a plurality of light sources that emit modulated light in the monitoring area by activating one or more of the light sources that are aligned with the location of the first object and by deactivating one or more of the light sources that are out of alignment with the location of the first object. The method can also include the steps of receiving reflections of the modulated light from the first object and determining a depth distance of the first object based at least in part on the reflections of the modulated light.

The method can also include the steps of determining a new location of the first object in the monitoring area resulting from movement of the first object and controlling the plurality of light sources by activating one or more of the light sources that are aligned with the new location of the first object. At least some of the activated light sources that are aligned with the new location may have been previously deactivated from being out of alignment with the previous location of the first object. The method can also include the step of controlling the plurality of light sources by deactivating one or more of the light sources that are out of alignment with the new location of the first object. At least some of the deactivated light sources that are out of alignment with the new location may have been previously activated from being aligned with the previous location of the first object.

The method can also include the steps of determining that a second object is present in the monitoring area at the same time as the first object and in response to determining that the second object is present, passively tracking the first and second objects. In one arrangement, passively tracking the first and second objects can include determining a location of the first object and the second object in the monitoring area and controlling the plurality of light sources that emit modulated light in the monitoring area by activating one or more of the light sources that are aligned with at least one of the location of the first object or the location of the second object and by deactivating one or more of the light sources that are out of alignment with both the location of the first object and the second object. The method can also include the steps of receiving reflections of the modulated light from the first and second objects and determining a depth distance of the first object and the second object based at least in part on the reflections of the modulated light. The method can also include the steps of determining the first object is no longer present in the monitoring area and no other objects are present in the monitoring area and in response, controlling the plurality of light sources by deactivating all the light sources.

A method of reducing the effects of MPP arising from the operation of a ToF sensor with a plurality of light sources that emit modulated light in a monitoring area is also described herein. The monitoring area may be partitioned into a plurality of segments, and the light sources correspond to the segments. The method can include the steps of receiving tracking data associated with an object in the monitoring area and analyzing the tracking data to determine which of the segments may be occupied by the object. The method can further include the steps of activating the light sources that correspond to the segments that are occupied by the object and deactivating the light sources that correspond to the segments that are unoccupied by the object. The method can also include the steps of emitting modulated light from only the activated light sources, receiving reflections of the modulated light from the object, and based on the received reflections, providing a depth distance of the object in the monitoring area with respect to the ToF sensor.

In one example, activating the light sources can include switching the light sources into an active state or maintaining the light sources in an active state. In another example, deactivating the light sources can include switching the light sources into a deactivated state or maintaining the light sources in a deactivated state. Each light source may correspond to a single segment of the monitoring area

### BRIEF DESCRIPTION OF THE DRAWINGS

FIG. 1 illustrates an example of a passive-tracking system for passively tracking one or more objects.

FIG. 2 illustrates a block diagram of an example of a passive-tracking system for passively tracking one or more objects.

FIG. 3A illustrates an example of a passive-tracking system with a field-of-view.

FIG. 3B illustrates an example of a coordinate system with respect to a passive-tracking system.

FIG. 3C illustrates an example of an adjusted coordinate system with respect to a passive-tracking system.

FIG. 4A illustrates a block diagram of an example of a ToF sensor.

FIG. 4B illustrates a block diagram of another example of a ToF sensor.

FIG. 5 illustrates an example of a monitoring area with a human object located therein.

FIG. 6 illustrates an example of a monitoring area with two human objects located therein.

For purposes of simplicity and clarity of illustration, elements shown in the above figures have not necessarily been drawn to scale. For example, the dimensions of some of the elements may be exaggerated relative to other elements for clarity. Further, where considered appropriate, reference numbers may be repeated among the figures to indicate corresponding, analogous, or similar features. In addition, numerous specific details are set forth to provide a thorough understanding of the embodiments described herein. Those of ordinary skill in the art, however, will understand that the embodiments described herein may be practiced without these specific details.

### DETAILED DESCRIPTION

As previously explained, a ToF sensor is designed to emit modulated light to help determine a distance between the ToF sensor and an object. Current ToF sensors, however, suffer from performance problems arising from multipath propagation (MPP). In particular, the effects of MPP may cause the ToF sensor to generate inaccurate distance readings.

To address this problem, systems and methods for reducing MPP in a ToF sensor are described herein. The ToF sensor can include a plurality of light sources that emit modulated light in a monitoring area, which may be partitioned into a number of segments. The light sources may correspond to the segments. Tracking data of an object in the area can be analyzed to determine which segments are occupied by the object. The light sources corresponding to the segments occupied by the object can be activated, and the light sources corresponding to the segments unoccupied by the object can be deactivated. Modulated light may be emitted from only the activated light sources, and reflections of the modulated light from the object can be received. Based on the received reflections, a depth distance of the object with respect to the ToF sensor can be provided.

In view of this arrangement, a ToF sensor can prevent light from illuminating unimportant sections of a monitoring area, thereby reducing extraneous reflections of modulated light that may lead to erroneous depth readings. This improvement can be accomplished without incurring excessive expenses or wasting emitted light.

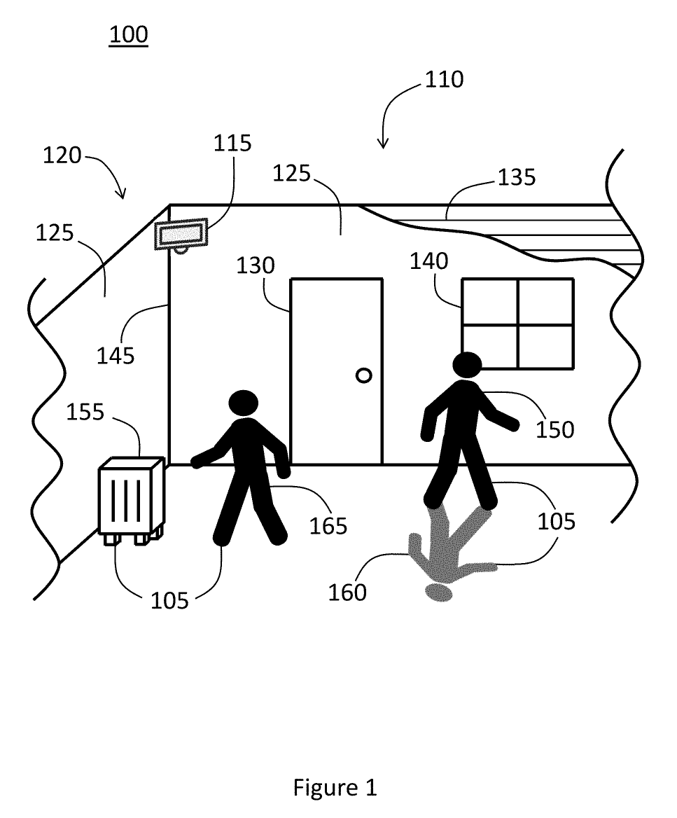

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. Those of skill in the art, however, will understand that the embodiments described herein can be practiced without these specific details.

Several definitions that are applicable here will now be presented. The term “sensor” is defined as a component or a group of components that include at least some circuitry and are sensitive to one or more stimuli that are capable of being generated by or reflected off or originating from a living being, composition, machine, etc. or are otherwise sensitive to variations in one or more phenomena associated with such living being, composition, machine, etc. and provide some signal or output that is proportional or related to the stimuli or the variations. An “object” is defined as any real-world, physical object or one or more phenomena that results from or exists because of the physical object, which may or may not have mass. An example of an object with no mass is a human shadow.

The term “monitoring area” is an area or portion of an area, whether indoors, outdoors, or both, that is the actual or intended target of observation or monitoring for one or more sensors. A “light source” is defined as a component that emits light, where the emission results from electrical power or a chemical reaction (or both). The term “modulate” and variations thereof are defined as varying one or more properties of one or more electromagnetic waves to affect the waves in some predetermined manner. The term “reduce” and variations thereof are defined as to lower or bring down, such as an amount or intensity of something, and includes a complete or substantial elimination. The term “activate” and variations thereof are defined as to switch on or to an active state or to maintain an on or active state. The term “deactivate” and variations thereof are defined as to switch off or to a deactivated state or to maintain an off state or a deactivated state. The term “segment” is defined as a portion of a monitoring area, whether in two or three dimensions, in real-world space or in a digital setting. An “array of light sources” is defined as a predetermined grouping of light sources. An “optical element” is defined as an element that modifies the propagation of light. A “shared optical element” is an optical element that modifies the propagation of light received from a plurality of light sources.

A “frame” is defined as a set or collection of data that is produced or provided by one or more sensors or other components. As an example, a frame may be part of a series of successive frames that are separate and discrete transmissions of such data in accordance with a predetermined frame rate. A “reference frame” is defined as a frame that serves as a basis for comparison to another frame. A “visible-light frame” is defined as a frame that at least includes data that is associated with the interaction of visible light with an object or the presence of visible light in a monitoring area or other location. A “sound frame” or a “sound-positioning frame” is defined as a frame that at least includes data that is associated with the interaction of sound with an object or the presence of sound in a monitoring area or other location. A “temperature frame” or a “thermal frame” is defined as a frame that at least includes data that is associated with thermal radiation emitted from an object or the presence of thermal radiation in a monitoring area or other location. A “positioning frame” or a “modulated-light frame” is defined as a frame that at least includes data that is associated with the interaction of modulated light (which can include pulsed light) with an object or the presence of modulated light in a monitoring area or other location. The term “tracking data” is defined as data that at least includes positioning data associated with an object. As an example, tracking data may be part of the set or collection of data that makes up a frame.

A “thermal sensor” is defined as a sensor that is sensitive to at least thermal radiation or variations in thermal radiation emitted from an object. A “time-of-flight sensor” is defined as a sensor that emits modulated light (which can include pulsed light) and is sensitive to at least reflections of the modulated light from an object. A “visible-light sensor” is defined as a sensor that is sensitive to at least visible light that is reflected off or emitted from an object. A “transducer” is defined as a device that is configured to at least receive one type of energy and convert it into a signal in another form. A “sonar device” is defined as a set of one or more transducers, whether such set of transducers is configured for phased-array operation or not. A “processor” is defined as a circuit-based component or group of circuit-based components that are configured to execute instructions or are programmed with instructions for execution (or both), and examples include single and multi-core processors and co-processors. A “pressure sensor” is defined as a sensor that is sensitive to at least variations in pressure in some medium. Examples of a medium include air or any other gas (or gases) or liquid. The pressure sensor may be configured to detect changes in other phenomena.

The term “circuit-based memory element” is defined as a memory structure that includes at least some circuitry (possibly along with supporting software or file systems for operation) and is configured to store data, whether temporarily or persistently. A “communication circuit” is defined as a circuit that is configured to support or facilitate the transmission of data from one component to another through one or more media, the receipt of data by one component from another through one or more media, or both. As an example, a communication circuit may support or facilitate wired or wireless communications or a combination of both, in accordance with any number and type of communications protocols.

The term “communicatively coupled” is defined as a state in which signals may be exchanged between or among different circuit-based components, either on a uni-directional or bi-directional basis, and includes direct or indirect connections, including wired or wireless connections. The term “optically coupled” is defined as a state, condition, or configuration in which light may be exchanged between or among different circuit-based components, either on a uni-directional or bi-directional basis, and includes direct or indirect connections, including wired or wireless connections.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). The term “plurality” is defined as two or more. Additional definitions may appear below.

Referring to FIG. 1, an example of a system 100 for tracking one or more objects 105 in a monitoring area 110 is shown. In one arrangement, the system 100 may include one or more passive-tracking systems 115, which may be configured to passively track any number of the objects 105. The term “passive-tracking system” is defined as a system that is capable of passively tracking an object. The term “passively track” or “passively tracking” is defined as a process in which a position of an object, over some time, is monitored, observed, recorded, traced, extrapolated, followed, plotted, or otherwise provided (whether the object moves or is stationary) without at least the object being required to carry, support, or use a device capable of exchanging signals with another device that are used to assist in determining the object's position. In some cases, an object that is passively tracked may not be required to take any active step or non-natural action to enable the position of the object to be determined. Examples of such active steps or non-natural actions include the object performing gestures, providing biometric samples, or voicing or broadcasting certain predetermined audible commands or responses. In this manner, an object may be tracked without the object acting outside its ordinary course of action for a particular environment or setting. For purposes of this description, passive tracking may include tracking an object such that one, two, or three positional coordinates of the object are determined and updated over time (if necessary). For example, passive tracking may include a process in which only two positional coordinates of an object are determined and updated.

In one case, the object 105 may be a living being. Examples of living beings include humans and animals (such as pets, service animals, animals that are part of an exhibition, etc.). Although plants are not capable of movement on their own, a plant may be a living being that is tracked or monitored by the system described herein, particularly if they have some significant value and may be vulnerable to theft or vandalism. An object 105 may also be a non-living entity, such as a machine or a physical structure, like a wall or ceiling. As another example, the object 105 may be a phenomenon that is generated by or otherwise exists because of a living being or a non-living entity, such as a shadow, disturbance in a medium (e.g., a wave, ripple or wake in a liquid), vapor, or emitted energy (like heat or light).

The monitoring area 110 may be an enclosed or partially enclosed space, an open setting, or any combination thereof. Examples include man-made structures, like a room, hallway, vehicle or other form of mechanized transportation, porch, open court, roof, pool or other artificial structure for holding water of some other liquid, holding cells, or greenhouses. Examples also include natural settings, like a field, natural bodies of water, nature or animal preserves, forests, hills or mountains, or caves. Examples also include combinations of both man-made structures and natural elements.

In the example here, the monitoring area 110 is an enclosed room 120 (shown in cut-away form) that has a number of walls 125, an entrance 130, a ceiling 135 (also shown in cut-away form), and one or more windows 140, which may permit natural light to enter the room 120. Although coined as an entryway, the entrance 130 may be an exit or some other means of ingress and/or egress for the room 120. In one embodiment, the entrance 130 may provide access (directly or indirectly) to another monitoring area 110, such as an adjoining room or one connected by a hallway. In such a case, the entrance 130 may also be referred to as a portal, particularly for a logical mapping scheme. In another embodiment, the passive-tracking system 115 may be positioned in a corner 145 of the room 120 or in any other suitable location. These parts of the room 120 may also be considered objects 105.

As will be explained below, the passive-tracking system 115 may be configured to passively track any number of objects 105 in the room 120, including both stationary and moving objects 105. In this example, one of the objects 105 in the room 120 is a human 150, another is a portable heater 155, and yet another is a shadow 160 of the human 150. The shadow 160 may be caused by natural light entering the room through the window 140. A second human 165 may also be present in the room 120. Examples of how the passive-tracking system 115 can distinguish the human 150 from the portable heater 155, the shadow 160, and the second human 165 and passively track the human 150 (and the second human 165) can be found in U.S. patent application Ser. No. 15/359,525, filed on Nov. 22, 2016, which is herein incorporated by reference.

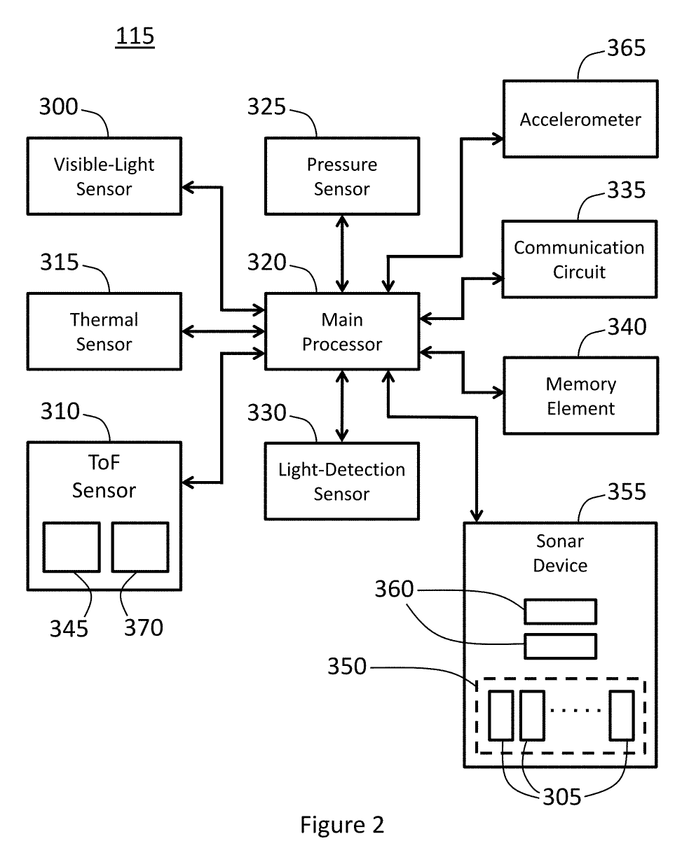

Referring to FIG. 2, a block diagram of an example of a passive-tracking system 115 is shown. In this embodiment, the passive-tracking system 115 can include one or more visible-light sensors 300, one or more sound transducers 305, one or more time-of-flight (ToF) sensors 310, one or more thermal sensors 315, and one or more main processors 320. The passive-tracking system 115 may also include one or more pressure sensors 325, one or more light-detection sensors 330, one or more communication circuits 335, and one or more circuit-based memory elements 340. Each of the foregoing devices can be communicatively coupled to the main processor 320 and to each other, where necessary. Although not pictured here, the passive-tracking system 115 may also include other components to facilitate its operation, like power supplies (portable or fixed), heat sinks, displays or other visual indicators (like LEDs), speakers, and supporting circuitry.

In one arrangement, the visible-light sensor 300 can be a visible-light camera that is capable of generating images or frames based on visible light that is reflected off any number of objects 105. These visible-light frames may also be based on visible light emitted from the objects 105 or a combination of visible light emitted from and reflected off the objects 105. In this description, the non-visible light may also contribute to the data of the visible-light frames, if such a configuration is desired. The rate at which the visible-light sensor 300 generates the visible-light frames may be periodic at regular or irregular intervals (or a combination of both) and may be based on one or more time periods. In addition, the rate may also be set based on a predetermined event (including a condition), such as adjusting the rate in view of certain lighting conditions or variations in equipment. The visible-light sensor 300 may also be capable of generating visible-light frames based on any suitable resolution and in full color or monochrome. In one embodiment, the visible-light sensor 300 may be equipped with an IR filter (not shown), making it responsive to only visible light. As an alternative, the visible-light sensor 300 may not be equipped with the IR filter, which can enable the sensor 300 to be sensitive to IR light.

The sound transducer 305 may be configured to at least receive soundwaves and convert them into electrical signals for processing. As an example, the passive-tracking system 115 can include an array 350 of sound transducers 305, which can make up part of a sonar device 355. The sonar device 355 may be referred to as a sensor of the passive-tracking system 115, even though it may be comprised of various discrete components, including at least some of these described here. As another example, the sonar device 355 can include one or more sound transmitters 360 configured to transmit, for example, ultrasonic sound waves in at least the monitored area 110. That is, the array 350 of sound transducers 305 may be integrated with the sound transmitters 360 as part of the sonar device 355. The sound transducers 305 can capture and process the sound waves that are reflected off the objects 105.

In one embodiment, the sound transducers 305 and the sound transmitters 360 may be physically separate components. In another arrangement, one or more of the sound transducers 305 may be configured to both transmit and receive soundwaves. In this example, the sound transmitters 360 may be part of the sound transducers 305. If the sound transducers 305 and the sound transmitters 360 are separate devices, the sound transducers 305 may be arranged horizontally in the array 350, and the sound transmitters 360 may be positioned vertically in the array 350. This configuration may be reversed, as well. In either case, the horizontal and vertical placements can enable the sonar device 355 to scan in two dimensions. The sound transducers 305 may also be configured to capture speech or other sounds that are audible to humans or other animals, which may originate from sources other than the sound transmitters 360.

The ToF sensor 310 can be configured to emit modulated light (which can include pulsed light) in the monitoring area 110 or some other location and to receive reflections of the modulated light off an object 105, which may be within the monitoring area 110 or other location. The ToF sensor 310 can convert the received reflections into electrical signals for processing. As part of this step, the ToF sensor 310 can generate one or more frames of positioning frames or modulated-light frames in which the data of such frames is associated with the reflections of modulated light off the objects 105. This data may also be associated with light from sources other than those that emit modulated-light and/or from sources other than those that are part of the ToF sensor 310. If the ToF sensor 310 is configured with a filter to block out wavelengths of light that are outside the frequency (or frequencies) of its emitted modulated light, the light from these other sources may be within such frequencies. As an example, the ToF sensor 310 can include a plurality of modulated light sources 345 and one or more imaging sensors 370, and the phase shift between the illumination and the received reflections can be translated into positional data. As an example, the light emitted from the ToF sensor 310 may have a wavelength that is outside the range for visible light, such as infrared (including near-infrared) light. Additional information about the ToF sensor 310 will be presented below.

The thermal sensor 315 can detect thermal radiation emitted from any number of objects 105 in the monitoring area 110 or some other location and can generate one or more thermal or temperatures frames that include data associated with the thermal radiation from the objects 105. The objects 105 from which the thermal radiation is emitted can be from living beings or from machines, like portable heaters, engines, motors, lights, or other devices that give off heat and/or light. As another example, sunlight (or other light) that enters the monitoring area 110 (or other location) may also be an object 105, as the thermal sensor 315 can detect thermal radiation from this condition or from its interaction with a physical object 105 (like a floor). As an example, the thermal sensor 315 may detect thermal radiation in the medium-wavelength-infrared (MWIR) and/or long-wavelength-infrared (LWIR) bands.

The main processor 320 can oversee the operation of the passive-tracking system 115 and can coordinate processes between all or any number of the components (including the different sensors) of the system 115. Any suitable architecture or design may be used for the main processor 320. For example, the main processor 320 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software or cause it to be executed (or any combination of the foregoing). Further examples of suitable processors include, but are not limited to, a central processing unit (CPU), an array processor, a vector processor, a field-programmable gate array (FPGA), a programmable logic array (PLA), an application specific integrated circuit (ASIC), and programmable logic circuitry. The main processor 320 can include at least one hardware circuit (e.g., an integrated circuit) configured to carry out instructions contained in program code.

In arrangements in which there is a plurality of main processors 320, such processors 320 can work independently from each other or one or more processors 320 can work in combination with each other. In one or more arrangements, the main processor 320 can be a main processor of some other device, of which the passive-tracking system 115 may or may not be a part. This description about processors may apply to any other processor that may be part of any system or component described herein, including any of the individual sensors or other components of the passive-tracking system 115. That is, any one of the sensors of the passive-tracking system 115 can have one or more processors similar to the main processor 320 described here.

The pressure sensor 325 can detect pressure variations or disturbances in virtually any type of medium, such as air or liquid. As an example, the pressure sensor 325 can be an air pressure sensor that can detect changes in air pressure in the monitored area 110 (or some other location), which may be indicative of an object 105 entering or otherwise being in the monitored area 110 (or other location). For example, if a human passes through an opening (or portal) to a monitored area 110, a pressure disturbance in the air of the monitored area 110 is detected by the pressure sensor 325, which can then lead to some other component taking a particular action.

The pressure sensor 325 may be part of the passive-tracking system 115, or it may be integrated with another device, which may or may not be positioned within the monitoring area 110. For example, the pressure sensor 325 may be a switch that generates a signal when a door or window that provides ingress/egress to the monitoring area 110 is opened, either partially or completely. Moreover, the pressure sensor 325 may be configured to detect other disturbances, like changes in an electro-magnetic field or the interruption of a beam of light (i.e., visible or non-visible). As an option, no matter what event may trigger a response in the pressure sensor 325, a minimum threshold may be set (and adjusted) to provide a balance between ignoring minor variations that would most likely not be reflective of an object 105 that warrants passive tracking entering the monitoring area 110 (or other location) and processing disturbances that most likely would be. In addition to acting as a trigger for other sensors or components of the passive-tracking system 115, the pressure sensor 325 may also generate one or more pressure frames, which can include data based on, for example, pressure variations caused by or originating from an object 105.

The light-detection circuit 330 can detect an amount of light in the monitoring area 110 (or other location), and this light may be from any number and type of sources, such as natural light, permanent or portable lighting fixtures, portable computing devices, flashlights, fires (including from controlled or uncontrolled burning), or headlights. Based on the amount of light detected by the light-detection circuit 330, one or more of the other devices of the passive-tracking system 115 may be activated or deactivated, examples of which will be provided later. Like the pressure sensor 325, the light-detection circuit 330 can be a part of the passive-tracking system 115 or some other device. In addition, minimum and maximum thresholds may be set (and adjusted) for the light-detection circuit 330 for determining which lighting conditions may result in one or more different actions occurring.

The communication circuits 335 can permit the passive-tracking system 115 to exchange data with other passive-tracking systems 115, a hub, or any other device, system, or network. To support various type of communication, including those governed by certain protocols or standards, the passive-tracking system 115 can include any number and kind of communication circuits 335. For example, communication circuits 335 that support wired or wireless (or both) communications may be used here, including for both local- and wide-area communications. Examples of protocols or standards under which the communications circuits 335 may operate include Bluetooth, Near Field Communication, and Wi-Fi, although virtually any other specification for governing communications between or among devices and networks may govern the communications of the passive-tracking system 115. Although the communication circuits 335 may support bi-directional exchanges between the system 115 and other devices, one or more (or even all) of such circuits 335 may be designed to only support unidirectional communications, such as only receiving or only transmitting signals.

The circuit-based memory elements 340 can be include any number of units and type of memory for storing data. As an example, a circuit-based memory element 340 may store instructions and other programs to enable any of the components, devices, sensors, and systems of the passive-tracking system 115 to perform their functions. As an example, a circuit-based memory element 340 can include volatile and/or non-volatile memory. Examples of suitable data stores here include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. A circuit-based memory element 340 can be part of the main processor 320 or can be communicatively connected to the main processor 320 (and any other suitable devices) for use thereby. In addition, any of the various sensors and other parts of the passive-tracking system 115 may include one or more circuit-based memory elements 340.

The passive-tracking system 115 is not necessarily limited to the foregoing design, as it may not necessarily include each of the previously listed components. Moreover, the passive-tracking system 115 may include components beyond those described above. For example, instead of or in addition to the sonar device 355, the system 115 can include a radar array, such as a frequency-modulated, continuous-wave (FMCW) system, that emits a sequence of continuous (non-pulsed) signals at different frequencies, which can be linearly spaced through the relevant spectrum. The results, which include the amplitude and phase of the reflected waves, may be passed through a Fourier transform to recover, for example, spatial information of an object 105. One example of such spatial information is a distance of the object 105 from the array. In some FMCW systems, the distances wrap or otherwise repeat—a discrete input to a Fourier transform produces a periodic output signal—and a tradeoff may be necessary between the maximum range and the number of frequencies used.

Some or all of the various components (e.g., sensors) of the passive-tracking system 115 may be oriented in a particular direction. These orientations may be fixed, although they may also be adjusted if necessary. As part of the operation of the passive-tracking system 115, some of the outputs of the different components of the system 115 may be compared or mapped against those of one or more other components of the system 115. To accommodate such an arrangement, the orientations of one or more components of the passive-tracking system 115 may be set so that they overlap one another.

A particular sensor of the passive-tracking system 115 may have a field-of-view (FoV), which may define the boundaries of an area that are within a range of operation for that sensor. As an example, the visible-light sensor 300, depending on its structure and orientation, may be able to capture image data of every part of a monitoring area 110 or only portions of the area 110. The FoV for one or more of the other components of the passive-tracking system 115 may be substantially aligned with the FoV of the visible-light sensor 300. For example, the FoV for the array 350 of sound transducers 305, ToF sensor 310, thermal sensor 315, and pressure sensor 325 may be effectively matched to that of the visible-light sensor 300. As part of this arrangement, the FoV for one particular component of the passive-tracking system 115 may be more expansive or narrower in comparison to that of another component of the passive-tracking system 115, although at least some part of their FoVs may be aligned. This alignment process can enable data from one or more of the sensors of the passive-tracking system 115 to be compared and merged or otherwise correlated with data from one or more other sensors of the system 115. Some benefits to this arrangement include the possibility of using a common coordinate or positional system among different sensors and confirmation of certain readings or other data from a particular sensor.

If desired, the orientation of the passive-tracking system 115 (as a whole) may be adjusted, either locally or remotely, and may be moved continuously or periodically according to one or more intervals. In addition, the orientations of one or more of the sensors (or other components) of the passive-tracking system 115 may be adjusted or moved in a similar fashion, either individually (or independently) or synchronously with other sensors or components. Any changes in orientation may be done while maintaining the alignments of one or more of the FoVs, or the alignments may be dropped or altered. Optionally, the system 115 or any component thereof may include one or more accelerometers 365, which can determine the positioning or orientation of the system 115 overall or any particular sensor or component that is part of the system 115. The accelerometer 365 may provide, for example, attitude information with respect to the system 115.

As presented as an earlier example, a passive-tracking system 115 may be assigned to a monitoring area 110 (or some other location), which may be a room 120 that has walls 125, an entrance 130, a ceiling 135, and windows 140 (see FIG. 1). Any number of objects 105 may be in the room 120 at any particular time, such as the human 150, the portable heater 155, and the shadow 160. As also noted above, many of the sensors of the passive-tracking system 115 may generate one or more frames, which may include data associated with, for example, the monitoring area 110, in this case, the room 120. For example, the visible-light sensor 300 may generate at any particular rate one or more visible-light frames that include visible-light data associated with the room 120. As part of this process, visible light that is reflected off one or more objects 105 of the room 120, like the walls 125, entrance 130, ceiling 135, windows 140, and heater 155, can be captured by the visible-light sensor 300 and processed into the data of the visible-light frames. In addition, as pointed out earlier, the visible light that is captured by the visible-light sensor 300 may be emitted from an object 105, and this light may affect the content of the visible-light frames.

In one arrangement, one or more of these visible-light frames may be set as visible-light reference frames, to which other visible-light frames may be compared. For example, in an initial phase of operation, the visible-light sensor 300 may capture images of the room 120 and can generate the visible-light frames, which may contain data about the layout of the room 120 and certain objects 105 in the room 120 that are present during this initial phase. Some of the objects 105 may be permanent fixtures of the room 120, such as the walls 125, entrance 130, ceiling 135, windows 140, and heater 155 (if the heater 155 is left in the room 120 for an extended period of time). As such, these initial visible-light frames can be set as visible-light reference frames and can be stored in, for example, the circuit-based memory element 340 or some other database for later retrieval. Because these objects 105 may be considered permanent or recognized fixtures of the room 120, as an option, a decision can be made that passively tracking such objects 105 is unnecessary or not helpful. Other objects 105, not just permanent or recognized fixtures of the room 120, may also be ignored for purposes of passively tracking.

As such, because these insignificant objects 105 may not be passively tracked, they can be used to narrow the focus of the passive-tracking process. For example, assume one or more visible-light reference frames include data associated with one or more objects 105 that are not to be passively tracked. When the visible-light sensor 300 generates a current visible-light frame and forwards it to the main processor 320, the main processor 320 may retrieve the visible-light reference frame and compare it to the current visible-light frame. As part of this comparison, the main processor 320 can ignore the objects 105 in the current frame that are substantially the same size and are in substantially the same position as the objects 105 of the reference frame. The main processor 320 can then focus on new or unidentified objects 105 in the current visible-light frame that do not appear as part of the visible-light reference frame, and they may be suitable candidates for passive tracking. The principles and examples described above may also apply to some of the other components, such as the sonar device 355, the thermal sensor 315, or the ToF sensor 310, of the passive-tracking system 115.

As part of passively tracking objects 105, the main processor 320 can receive and analyze frames from one or more of the sensors of the passive-tracking system 115. Some of this analysis may include the main processor 320 comparing the data of the frames to one or more corresponding reference frames. In one embodiment, following the comparison, some of the data of the frames from the different sensors may be merged for additional analysis or actions. For example, relevant data from the frames generated by the visible-light sensor 300 and the thermal sensor 315 may be combined. Based on this combination, the main processor 320 may determine positional or tracking data associated with an object 105 in the monitoring area 110, and this tracking data may be updated over time. In one embodiment, this tracking data may conform to a known reference system, such as a predetermined coordinate system, with respect to the location of the passive-tracking system 115.

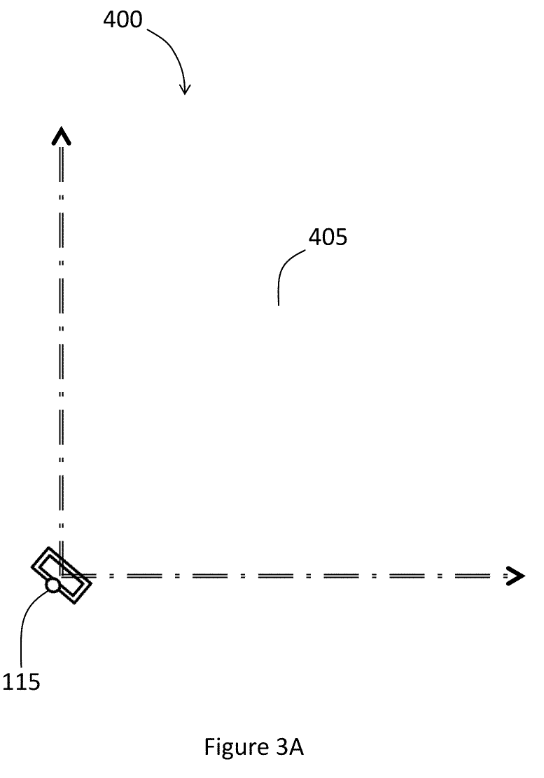

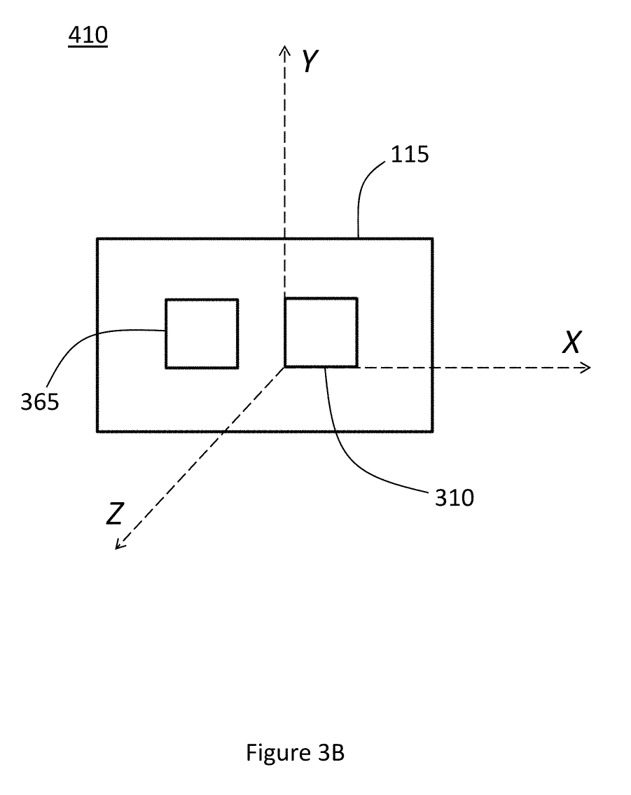

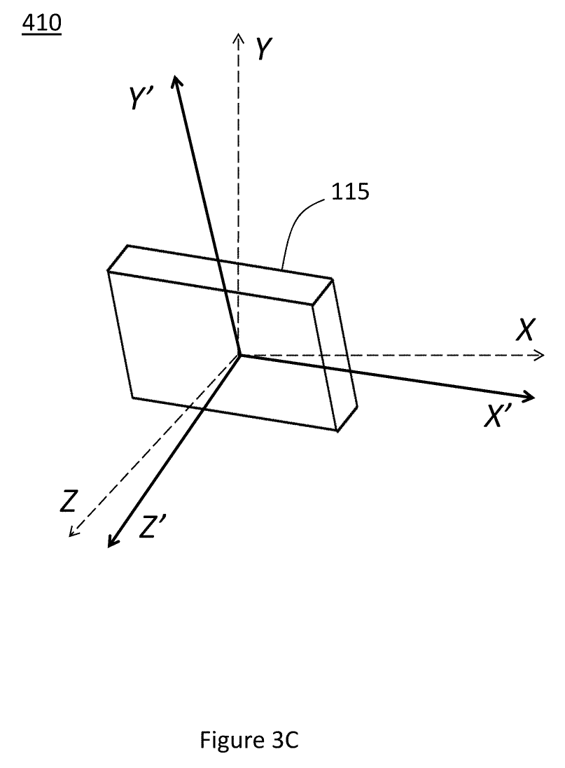

Referring to FIG. 3A, an example of the passive-tracking system 115 in a monitoring area 110 with a field of view (FoV) 400 is shown. In one arrangement, the FoV 400 is the range of operation of a sensor of the passive-tracking system 115. For example, the visible-light sensor 300 may have a FoV 400 in which objects 105 or portions of the objects 105 within the area 405 of the FoV 400 may be detected and processed by the visible-light sensor 300. In addition, the ToF sensor 310 and the thermal sensor 315 may each have a FoV 400. In one arrangement, the FoVs 400 for these different sensors may be effectively merged, meaning that the coverage areas for these FoVs 400 may be roughly the same. As such, the merged FoVs 400 may be considered an aggregate or common FoV 400. Of course, such a feature may not be necessary, but by relying on a common FoV 400, the data from any of the various sensors of the passive-tracking system 115 may be easily correlated with or otherwise mapped against that of any of the other sensors.

As an example, the coverage area of each (individual) FoV 400 may have a shape that is comparable to a pyramid or a cone, with the apex at the relevant sensor. To ensure substantial overlapping of the individual FoVs 400 for purposes of realizing the common FoV 400, the sensors of the passive-tracking system 115 may be positioned close to one another and may be set with similar orientations. As another example, the range of the horizontal component of each (individual) FoV 400 may be approximately 90 degrees, and the common FoV 400 may have a similar horizontal range as a result of the overlapping of the individual FoVs 400. This configuration may provide for full coverage of at least a portion of a monitoring area 110 if the passive-tracking system 115 is positioned in a corner of the area 110. The FoV 400 (common or individual), however, may incorporate other suitable settings or even may be adjusted, depending on, for instance, the configurations of the monitoring area 110.

In one embodiment, the FoV 400 may represent a standard or default range of operation of one or more sensors of the system 115, although the FoV 400 may not necessarily represent or otherwise match the coverage area of emissions of some of the sensors. For example, as will be explained below, the operation of one or more sensors may be adjusted, depending on one or more factors. As a specific example, the FoV 400 may represent the maximum coverage area of the light that the ToF sensor 310 emits when in a fully active state, or when each of the light sources 345 is activated. Of course, in other embodiments, the coverage area of the light that is emitted by the ToF sensor 310 when it is in the fully active state may be different from the FoV 400 pictured here. For example, the ToF sensor 310 may be configured to emit light in the fully active state at an angle that is wider (or narrower) than 90 degrees, and this emitted light may not necessarily assume the shape of a cone.

The ToF sensor 310 may not always operate in a fully active state. In some cases, a portion of the light sources 345 of the ToF sensor 310 may be deactivated, and this state may shrink the portion of the monitoring area 110 that is illuminated by the light. Such a state may be referred to as a partially active (or activated) state. In addition, depending on the orientation of the light sources 345 or the use of certain optical elements (or both), the light emitted by at least some of the light sources 345 may overlap in the FoV 400. This overlap may exist in either a fully or partially active state.

Referring to FIG. 3B, a positional or coordinate system 410 may be defined for the passive-tracking system 115. In one arrangement, the X axis and the Y axis may be defined by the ToF sensor 310, and the Z axis may be based on a direction pointing out the front of the ToF sensor 310 in which the direction is orthogonal to the X and Y axes. In this example, the ToF sensor 310 may be considered a reference sensor. Other sensors of the system 115 or various combinations of such sensors (like the visible-light sensor 300 and the ToF sensor 310) may act as the reference sensor(s) for purposes of defining the X, Y, and Z axes. To achieve consistency in the positional data that originates from the coordinate system 410, the sensors of the system 115 may be pointed or oriented in a direction that is at least substantially similar to that of the reference sensor.

In one arrangement, each of the sensors that provide positional data related to one or more objects may initially generate such data in accordance with a spherical coordinate system (not shown), which may include values for azimuth, elevation, and depth distance. Note that not all sensors may be able to provide all three spherical values. The sensors (or possibly the main processor 320 or some other device) may then convert the spherical values to Cartesian coordinates based on the X, Y, and Z axes of the coordinate system 410. This X, Y, and Z positional data may be associated with one or more objects 105 in the monitoring area 110, with the X data related to the azimuth values, Y data related to the elevation values, and Z data related to the depth-distance values.

In certain circumstances, the orientation of the passive-tracking system 115 may change. For example, the initial X, Y, and Z axes of the system 115 may be defined when the system 115 is placed on a flat surface. If the positioning of the system 115 shifts, however, adjustments to the coordinate system 410 may be necessary. For example, if the system 115 is secured to a higher location in a monitoring area 110, the system 115 may be aimed downward, thereby affecting its pitch. The roll and yaw of the system 115 may also be affected. As will be explained below, the accelerometer 365 may assist in making adjustments to the coordinate system 410.

Referring to FIG. 3C, the passive-tracking system 115 is shown in which at least the pitch and roll of the system 115 have been affected. The yaw of the system 115 may have also been affected. In one arrangement, however, the change in yaw may be assumed to be negligible. The initial X, Y, and Z axes are now labeled as X′, Y′, and Z′ (each in solid lines), and they indicate the shift in the position of the system 115. In one embodiment, the system 115 can define adjusted X, Y, and Z axes, which are labeled as X, Y, and Z (each with dashed lines), and the adjusted axes may be aligned with the initial X, Y, and Z axes of the coordinate system 410.

To define the adjusted X, Y, and Z axes, first assume the adjusted Y axis is a vertical axis passing through the center of the initial X, Y, and Z axes. The accelerometer 365 may provide information (related to gravity) that can be used to define the adjusted Y axis. The remaining adjusted X and Z axes may be assumed to be at right angles to the (defined) adjusted Y axis. In addition, an imaginary plane may pass through the adjusted Y axis and the initial Z axis, and a horizontal axis (with respect to the adjusted Y axis) that lies on this plane may be determined to be the adjusted Z axis. The adjusted X axis is found by identifying the only axis that is orthogonal to both the adjusted Y axis and the adjusted Z axis. One skilled in the art will appreciate that there are other ways to define the adjusted axes.

Once the adjusted X, Y, and Z axes are defined, the initial X, Y, and Z coordinates may be converted into adjusted X, Y, and Z coordinates. That is, if a sensor or some other device produces X, Y, and Z coordinates that are based on the initial X, Y, and Z axes, the system 115 can adjust these initial coordinates to account for the change in the position of the system 115. When referring to (1) a three-dimensional position, (2) X, Y, and Z positional data, (3) X, Y, and Z positions, or (4) X, Y, and Z coordinates, such as in relation to one or more objects 105 being passively tracked, these terms may be defined by the initial X, Y, and Z axes or the adjusted X, Y, and Z axes of the coordinate system 410 (or even both). Moreover, positional data related to an object 105 is not necessarily limited to Cartesian coordinates, as other coordinate systems may be employed, such as a spherical coordinate system. No matter whether initial or adjusted positional data is acquired by a passive-tracking system 115, the system 115 may share such data with other devices.

In accordance with the description above, current frames from the components or sensors of the passive-tracking system 115 may include various positional data, such as different combinations of data associated with the X, Y, and Z positions, related to one or more objects 105. For example, the visible-light sensor 300 and the thermal sensor 310 may provide data related to the X and Y positions of an object 105, and the data from the ToF sensor 310 may relate to the X, Y, and Z positions of the object 105. In some cases, the data about the Z positions provided by the ToF sensor 310 may receive significant attention because it provides depth distance, and the data associated with the X and Y positions from the ToF sensor 310 may either be ignored, filtered out, or used for some other purpose (like tuning or confirming measurements from another sensor). As another example, a sonar device 355 (see FIG. 2) may be useful for determining or confirming X and Z positions of an object 105.

In one arrangement, tracking data from the sensors of the passive-tracking system 115 may be useful for optimizing the operation of the ToF sensor 310. For example, X- and Y-positional data from the visible-light sensor 300 or the thermal sensor 315 (or both) can be used to cause the ToF sensor 310 to reduce the amount of modulated light reaching certain portions of the monitoring area 110. As another example, Z-positional data from the sonar device 355 of the system 115 may be relied on to facilitate a similar operation or to cause other adjustments in the operation of the ToF sensor 310. In some cases, positional data from the ToF sensor 310 itself may be used to manage its operation.

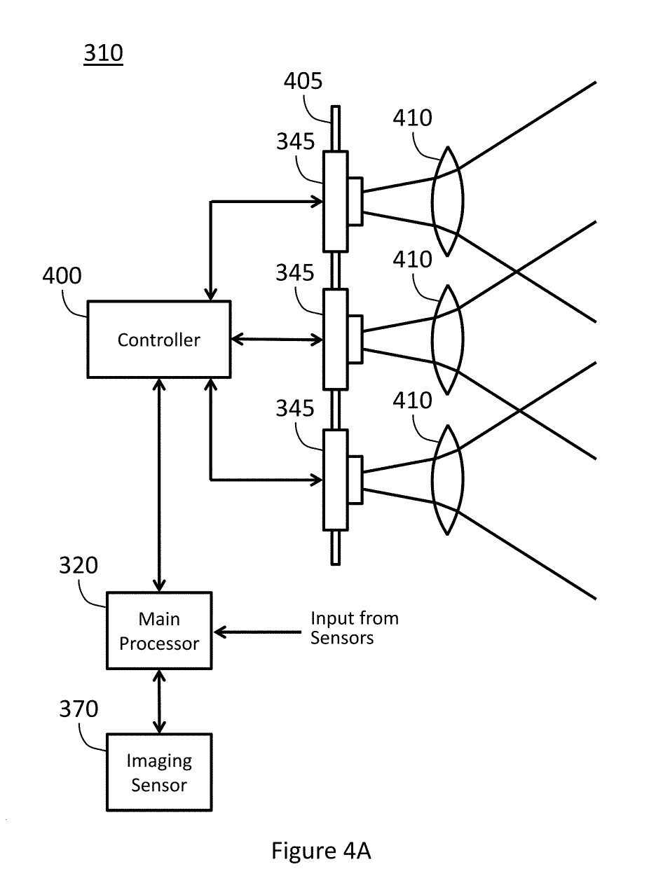

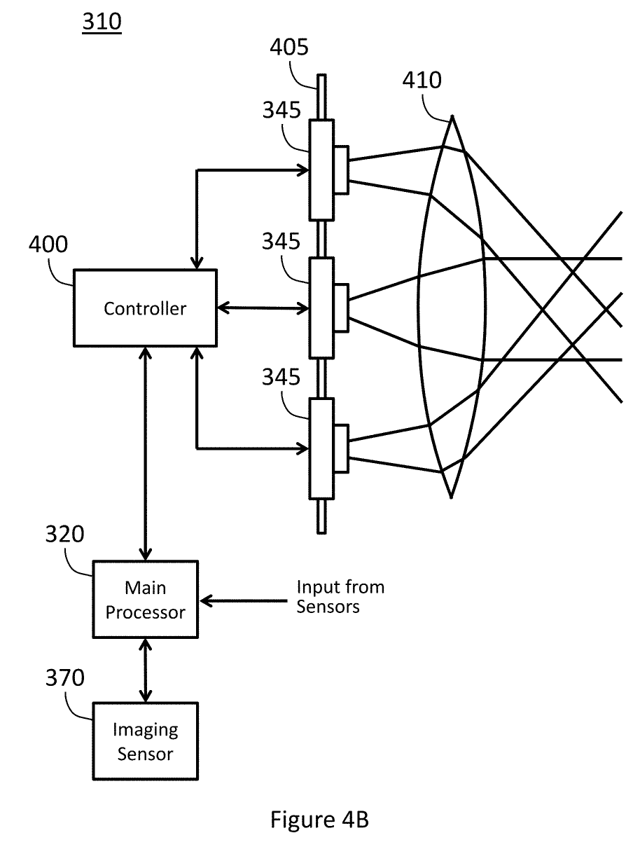

Before presenting examples of such a process, additional information about the ToF sensor 310 will be provided. Referring to FIGS. 4A and 4B, a block diagram that shows from a top view a possible configuration of the ToF sensor 310 is illustrated. The ToF sensor 310, as pointed out earlier, can include a plurality of modulated light sources 345 and one or more detectors or imaging sensors 370. The ToF sensor 310 may also include one or more controllers 400 for controlling the modulated light sources 345, such as by controlling the power to the light sources 345.

In one embodiment, the light sources 345 may be part of an array 405 that can support the light sources 345 and can help position or orient them. The array 405 can have any suitable layout or shape. As an example, the array 405 here may be horizontal in form (with the perspective of a top view). Of course, other configurations may be implemented, including more complicated arrangements, such as rectangular or hexagonal grids. No matter the form of the array 405, each of the light sources 345 may have an orientation, which can be a predetermined orientation, if desired. In the case of a predetermined orientation, a light source 345 may be positioned to direct the light that it emits to a particular component or section of the monitoring area 110. As will be explained later, other devices or factors may define the orientation of a light source 345. In another example, once the orientation of a light source 345 is set, the orientation may remain fixed. As an option, the light source 345 may be configured to permit it to be repositioned, which may be prompted by one or more events or some type of feedback from the operation of the ToF sensor 310. For example, the light source 345 (or the array 405) may include some mechanical or mechanized structure (not shown) to enable it to be positioned manually or through some automated means.

In accordance with an earlier example, the light sources 345 may be light sources that can emit light in the IR range, such as near-IR light. The light sources 345, however, can be configured to emit light of other suitable wavelengths, including those of other non-visible light, visible light, or a combination of visible light and non-visible light. As another example, the light sources 345 may be lasers, although other illumination sources (such as light-emitting diodes (LED), incandescent lamps, or even those that produce light from a chemical reaction) may be incorporated into the ToF sensor 310.

The ToF sensor 310 can also include one or more optical elements 410, which may be configured to modify the propagation of light. As an example, the optical elements 410 may be lenses, diffusers, or a combination of the two, although other structures that modify the propagation of light may be employed here. In one arrangement, all or at least a portion of the light sources 345 may be paired with an optical element 410, an example of which is shown in FIG. 4A. For example, the light sources 345 may be lasers, and a diffuser may be paired with each of the lasers. In this configuration, the diffusers may be positioned to point to a certain portion of the monitoring area 110. In another embodiment, the light sources 345 may be configured to emit light in a more scattered fashion. For example, the light sources 345 may be LEDs, and the optical elements 410 that are paired with the LEDs may be lenses, such as projection-type lenses. Such a lens may be configured to direct the emitted light (or at least assist its direction) to a certain portion of the monitoring area 110.

The use of a particular light source 345 or optical element 410 in the ToF sensor 310 may not necessarily be exclusive of other types. For example, a portion of the light sources 345 of the array 405 may be lasers, and another portion of the light sources 345 of the same array 405 may be LEDs or other types of light-emitting devices. Similarly, some of the optical elements 410 in the ToF sensor 310 may be diffusers, and another portion of them may be lenses or other devices that may modify the propagation of light. In another embodiment, the ToF sensor 310 may be configured without any optical elements 410, in which case, the light from the light sources 345 may be directly emitted to the monitoring area 110.

In another embodiment, the ToF 310 may include a shared optical element 410, an example of which is shown in FIG. 4B. Here, any number of the light sources 345, including all or a portion of them, of the ToF sensor 310 may be optically coupled to the shared optical element 410. For example, the light sources 345 may be lasers oriented to aim their light beams at a certain part of the shared optical element 410, which, in this case, may be a diffuser. As another example, the light sources 345 may be LEDs oriented to direct their light to some part of the shared optical element 410, which can be a projection-type lens in this setting. In either arrangement, the shared optical element 410 may assist in shaping the emitted light to cover a certain section of the monitoring area 110. Like the examples related to the discussion of FIG. 4A, any suitable combination of light sources 345 and shared optical elements 410 may be incorporated into the ToF sensor 310. As such, a ToF sensor 310 may have just a single shared optical element 410 or may have a plurality of them. For brevity in this description, any reference made to an optical element 410 may also be applicable to a shared optical element 410.

The main processor 320 may be communicatively coupled to and control the operation of several of the components of the ToF sensor 310, such as the light sources 345 (through the controller 400) and, if applicable, the optical element 410. The processor 320, as also previously noted, may receive input from the imaging sensor 370 of the ToF sensor 310 and from the other sensors of the passive-tracking system 115, such as the visible-light sensor 300, the thermal sensor 315, and/or the sonar device 355. Although the main processor 320, as presented in this configuration, may be a component separate and distinct from the ToF sensor 310, such an arrangement is not meant to be limiting, as the processor 320 or some other processor may be incorporated into or otherwise be part of the ToF sensor 310.

As noted earlier, the controller 400 may control the supply of power to the light sources 345. In one example, this control exerted by the controller 400 may be selective in nature, meaning that power may be supplied to all, none, or a portion of the light sources 345 at any given time. The controller 400 may perform this task under the direction of the main processor 320, which may signal the controller 400 to do so in response to some event or circumstance. When the controller 400 permits power to reach or to continue to reach a light source 345, the light source 345 may be in an active or activated state, and the light source 345 may emit modulated light. Thus, in the active state or when otherwise activated, the light source 345 may be switched on (from off) or may remain on. In either circumstance, the light source 345 may emit modulated light while in the active state.

In contrast, when the controller 400 prevents power from reaching a light source, the light source 345 may be in a deactivated state. The light source 345 may not emit light while in the deactivated state. In the deactivated state, the light source 345 may be switched off (from on) or may be maintained in an off state. Because the light sources 345 may illuminate a particular section of the monitoring area 345, selectively activating and deactivating the light sources 345 may enable the ToF sensor 310 to provide a form of illumination control for the monitoring area 110.

When at least some of the light sources 345 are in the active state, modulated light may be emitted in the monitoring area 110. In addition, the input signal of the modulated light from the active light sources 345 is not disturbed. As such, the ability of the ToF sensor 310 to determine depth distances should be maintained. This principle may remain true no matter how many light sources 345 are activate at a given time or the number of times the light sources 345 are switched from an activate state to a deactivated state, so long as at least one of the light sources 345 is activated.

As another option, the light sources 345 and the controller 400 may be configured to permit the controller 400 to modify the intensity of the modulated light emitted by the light sources 345. This modification can include an increase or a reduction in intensity to any suitable level and may affect all or only a portion of any active light sources 345. As an example, the intensity control can be achieved by changing the instantaneous intensity or the average intensity, such as by turning the light sources 345 on for varying amounts of time during data acquisition. Because a light source 345 may continue to receive power and, hence, emit light when the light's intensity is altered, the light source 345 may still be considered in an active state when the intensity is changed. Similar to switching the light sources 345 on or off, the main processor 320 may signal the controller 400 to perform this step, which may occur in view of some event or circumstance. Modifying the intensity of the light sources 345 may be carried out while the light sources 345 are selectively activated and deactivated or can be done without selectively activating and deactivating the light sources 345. In the case of the latter, at least some of the light sources 345 may be placed in an activated state to last for a certain period of time, and the intensity of such light sources 345 may be selectively modified.

Irrespective of the intensity or amount of modulated light that is emitted from the ToF sensor 310, at least some of the modulated light may be reflected back to the imaging sensor 370. The imaging sensor 370 may then convert the captured reflections into raw data that it can feed to the main processor 320. The main processor 320, based on this raw data, may then generate positional or tracking data associated with the object 105. The tracking data may include, for example, X, Y, and Z coordinates, with the Z coordinate arising from a depth distance for the object 105 with respect to the ToF sensor 310.

In one arrangement, the main processor 320 may receive the frames that are generated by the other sensors of the passive-tracking system 115, such as the visible-light sensor 300, the thermal sensor 315, the sonar device 355, or any combination thereof. For example, the visible-light sensor 300 and the thermal sensor 315 may generate frames that include data about one or more objects 105 in the monitoring area 110. The main processor 320 may receive and analyze these frames to determine whether any of the objects 105 are suitable for passive tracking. As an example, an object 105 that is human may be suitable for passive tracking. Objects 105 that are suitable for passive tracking may be referred to as candidates for passive tracking.

Continuing with the example, tracking data about the objects 105 detected by the visible-light sensor 300 and the thermal sensor 315 may form part of the data of the frames generated by these sensors. The processor 320 may extract and further process the tracking data to determine positional coordinates associated with the objects 105. In one arrangement, the processor 320 may determine the positional coordinates only for the objects 105 that have been identified as suitable for passive tracking (or are otherwise already being passively tracked). In the case of the frames from the visible-light sensor 300 and the thermal sensor 315, the positional coordinates may be X and Y coordinates associated with the objects 105 that have been designated as being suitable for passive tracking.

Positional coordinates may be acquired from tracking data generated by other sensors of the passive-tracking system 115. For example, main processor 320 may determine X and Z coordinates from the frames produced by the sonar device 355. Similar positional data may be obtained from frames generated by a radar unit. As another example, positional data may be received from different passive-tracking systems 115 or other devices or systems that may be remote to the instant passive-tracking system 115. Whatever positional coordinates are obtained from the sensors, the processor 320 may effectively determine a location in the monitoring area 110 of an object 105 that is being passively tracked. Although the location of the object 105 may be based on X, Y, and Z coordinates, the description here is not so limited. In particular, a location of an object 105 may be based on simply two coordinates or even a single coordinate. In the case of fewer than 3 coordinates, the main processor 320 may estimate the missing coordinate(s) or may simply include all possible values that may make up the missing coordinate(s).

In one embodiment, the main processor 320 may use the tracking data from the other sensors of the passive-tracking system 115 (or other device or system) to signal the controller 400 to selectively activate or deactivate (or both) one or more of the light sources 345. Whether a particular light source 345 is activated or deactivated may depend on its relation to the location of the object 105 being passively tracked.

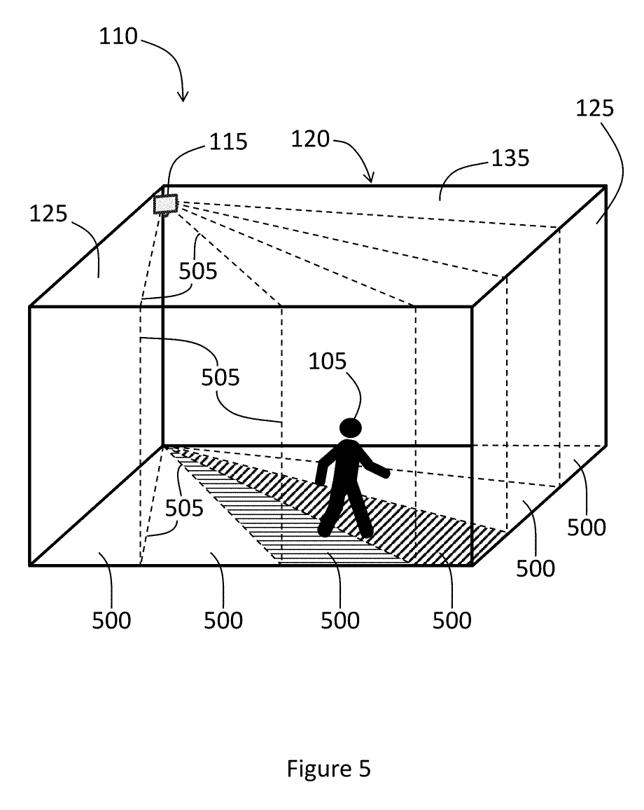

Referring to FIG. 5, an example of a monitoring area 110 with a human object 105 that is being passively tracked by the passive-tracking system 115 is shown. Reference will also be made to the elements shown in FIGS. 1-4 for purposes of the description related to FIG. 5. In one arrangement, the main processor 320 may have previously mapped the monitoring area 110. Specifically, the processor 320 may have received data from the various sensors (including the ToF sensor 310) of the passive-tracking system 115 to determine the physical boundaries of the monitoring area 110. For example, the monitoring area 110 may be the room 120 of FIG. 1, and the processor 320 may have identified the walls 125, ceiling 135, and floor of the room 120. Other structures may be a physical boundary of the room 120, even though that may not have been the original purpose of such structures. For example, a large piece of furniture may be positioned in the room 120 that effectively blocks access to a certain portion of the room 120.

Once the monitoring area 110 is mapped, the main processor 320 may partition the area 110 into any number of segments. An example of the result of this process can be seen in FIG. 5 in which the monitoring area 110 is partitioned into a plurality of segments 500. The segments 500 may each cover a portion of the monitoring area 110, and the dashed lines in FIG. 5 represent at least some of the boundaries 505 of the segments 500. The coverage of a segment 500 may be approximately equivalent to some portion of the monitoring area 110. In some cases, the segments 500 may represent a certain volume of the monitoring area 110, making them three-dimensional (3D), an example of which is shown in FIG. 5. The segments 500, however, may also be generated to encompass a particular area of the monitoring area 110, making them two-dimensional (2D). If 2D segments 500 are generated, they may be mapped against the monitoring area 110 at any suitable depth with respect to the ToF sensor 310. In either case, because the processor 320 may map the segments 500 against a digital representation of the monitoring area 110, the segments 500 may be referred to as virtual segments. In one arrangement, the segments 500 may be defined in terms of X and Y coordinates of one or more of the sensors of the passive-tracking system 115, such as a ToF or visible-light sensor. The segments 500 may be about equal in size and shape, although any number of them may have different sizes or shapes (or both) in comparison to other segments 500. Moreover, the processor 320 may be configured to modify the size or shape of any of the segments following their initial setting.

As is apparent from the explanation above, whatever form of segments 500 are generated, a segment 500 may be associated with at least some portion of the monitoring area 110. Thus, if an object 500 is present or absent in such portion of the monitoring area 110, it can be said that the object 500 has a respective presence or absence in the corresponding segment 500. This relationship may establish a bridge between the physical world (i.e., the portion of the monitoring area 110) and the digital environment (i.e., the segment 500). For purposes of this description then, when reference is made to an object 105 being located or positioned (entirely or partially) within a segment 500, the object 105 may also be considered in (entirely or partially) in the corresponding portion of the monitoring area 110 and vice-versa.

In one arrangement, the number of the segments 500 into which the monitoring area 110 is partitioned may be determined by the number of light sources 345 of the ToF sensor 310. As a specific example, a one-to-one correspondence may exist between the number of light sources 345 and segments 500 such that each segment 500 is associated with or assigned to a single light source 345. Thus, the number of light sources 345 of the ToF sensor 310 may equal the number of segments 500 of the monitoring area 110. This description is not meant to be so limiting, however, as a single segment 500 may be associated with multiple light sources 345, or multiple segments 500 may be linked to a single light source 345. Other combinations for the association of segments 500 to light sources 345 may be applicable. The number of light sources 345 may also help determine the size and shape of the corresponding segments 500. For example, if a ToF sensor 310 has a lot of light sources 345, a greater number of segments 500 associated with the monitoring area 110 may be needed, particularly if there is a one-to-one correspondence between them, and the sizes of the segments 500 may be smaller in comparison to those related to a ToF sensor 310 with fewer light sources 345.

As noted above, a segment 500 may be associated with a particular light source 345. As such, the generation of a segment 500 may be related to the orientation of the light source 345 and (possibly) the optical element 410 with which the light source 345 is paired, as the orientation of these two components may largely determine which portions of the monitoring area 110 are illuminated by the light from the light source 345. In other words, the process of partitioning the monitoring area 110 and creating the segments 500 may revolve around the portions of the monitoring area 110 that are or may be illuminated by the light from the light sources 345. How close the scope of a segment 500 is commensurate with the portion of the monitoring area 110 illuminated by the light from a light source 345 may be one of degree. For example, the scope of the segment 500 may be loosely affiliated with the illuminated portion, in which case these separate dimensions may be only roughly equivalent. In this scenario, the illuminated portion may be encapsulated by the segment 500, or it may extend beyond the boundaries of the segment 500.

In another arrangement, the scope of a segment 500 may be matched to a closer degree to the illuminated portion of the monitoring area 110 with respect to a certain light source 345. In such a configuration, the main processor 320 can be programmed with certain data, such as the orientations of the light sources 345 and the optical element(s) 410 and the portion of the monitoring area 110 that is illuminated by the light. As an example, the information about the illuminated portion may have been acquired from one or more simulations or from past use cases in similar physical environments. In another example, such information may also be learned from the passive-tracking system 115 interacting with the actual monitoring area 110. For example, if the visible-light sensor 300 is configured to process IR light, such as in a training mode, the visible-light sensor 300 may determine the space of the monitoring area 110 illuminated by the emitted light. Using this information, the processor 320 can generate a segment 500 with a scope that approximately matches the illuminated portion with respect to a certain light source 345.

Any combination of the data used to establish a segment 500 and tie it to a light source 345 may be referred to collectively as the orientation of the light source 345. For example, the positioning of the light source 345 by itself or in combination with a paired optical element 410 may be an orientation of the light source 345. Likewise, the portion of the monitoring area 110 illuminated by the light from the light source 345 may be defined as an orientation of the light source 345, either individually or in combination with the positioning of the light source 345 and (possibly) the optical element 410. As such, the orientation of a light source 345 may be comprised of one or more factors or settings.

In view of the relationship between a light source 345 and its corresponding segment 500, when a light source 345 is activated (and in conjunction with its optical element 410), its light may illuminate at least some part of the monitoring area 110 that is within the scope of the corresponding segment 500. If the light source 345 is deactivated, this illumination may be removed. As such, the presence or absence of an object 105 (like a human object 105) in a segment 500 may lead to the respective activation and deactivation of a light source 345. Examples of this process will be presented below.

In one embodiment, the light emitted from the ToF sensor 310, such as when all the light sources 345 are activated, may blanket the entire monitoring area 110 or at least a substantial portion thereof. In such an arrangement, the total space covered by the segments 500 may be approximately equal to the overall space of the monitoring area 110. If so, at least some of the segments 500 may have some part of their boundaries defined by the physical boundaries of the monitoring area 110. If the segments 500 are 2D, the total area of the segments 500 may be roughly equal to some (vertical) plane in the monitoring area 110, and at least some of the 2D segments 500 may have some of their boundaries set by the physical boundaries of the monitoring area 110.

Alternatively, the cumulative space or area of the generated segments 500 may not necessarily cover the entirety of the space or selected plane of the monitoring area 110. In particular, the ToF sensor 310 may be configured to avoid illuminating certain sections of the monitoring area 110, such as areas that may receive little to no human traffic. Examples of such areas include portions of the monitoring area 110 above a certain height or parts that restrict access, like an area through which ingress and egress is blocked by a large piece of furniture or shelving. In these portions of the monitoring area 110, it may not be necessary to generate segments 500 that cover them. This concept may remain true even if the light from one or more of the light sources 345 may illuminate such portions of the monitoring area 110.

As mentioned earlier, the illumination from one or more of the light sources 345 may overlap in the monitoring area 110. In one example, if illumination overlap exists, its presence can be considered in the creation of the segments 500 such that the scope of two or more segments 500 may correspondingly overlap. Alternatively, the scope of different segments 500 may be kept from overlapping, even if illumination overlap is present.

As presented thus far, the main processor 320 may partition the monitoring area 110 into the segments 500 depending on the positioning of the light sources 345 (and the optical elements 405) and/or the portion of the area 110 illuminated by the light from the light sources 345. In an alternative arrangement, the processor 320 may map the monitoring area 110 and partition it into the segments 500 prior to the positioning of the light sources 345 and/or the optical elements 410 being set. In this example, the positioning of a light source 345 and/or its optical element 410 may depend on its corresponding segment 500. These components may be positioned (following the partition of the monitoring area 110) manually or through some mechanized means.

Referring once again to the human object 105 of FIG. 5, the main processor 320 may receive tracking data from one or more of the sensors of the passive-tracking system 115 that may identify a location of the human object 105. For example, the processor 320 may determine X, Y, and Z coordinates of the human object 105. In this example, the tracking data may be obtained from the sensors of the system 115, other than the ToF sensor 310. Once the location of the human object 105 is acquired, the processor 320 may determine which segments 500 are occupied by the human object 105. In one embodiment, a segment 500 may be occupied by an object 105 if at least some portion of an object 105 is contained with a certain space or area or a representation of that space or area. For example, as shown in FIG. 5, the human object 105 may occupy at least two segments 500, the lower sections of which are shaded here, because at least some part of the object 105 is within the scope of the two segments 500. Moreover, in this example, it can be said that the human object 105 does not occupy the remaining segments 500. A segment 500 may be unoccupied by an object 105 if no portion of the object 105 is contained within a certain space or area or a representation of that space or area.

Once the main processor 320 determines which segments 500 the human object 105 occupies (and/or does not occupy), the processor 320 may signal the controller 400 to activate the light sources 345 that correspond to the occupied segments 500. In this case, the orientations of the activated light sources 345 may be considered in alignment with the location of the human object 105 because their corresponding segments 500 are occupied by the human object 105. In contrast, the processor 320 may signal the controller 400 to deactivate the light sources 345 that correspond to the unoccupied segments 500. The orientations of the deactivated light sources 345 may be considered out of alignment with the location of the human object 105 because their corresponding segments 500 are unoccupied by the human object 105. As a reminder, activating or deactivating a light source 345 may (respectively) involve switching the light source 345 on or maintaining it in a powered-on state or switching it off or maintaining it in a powered-off state.

At least some of the modulated light from the activated light sources 345 that reaches the human object 105 may be reflected back to the ToF sensor 310 and captured by the imaging sensor 370. Because the deactivated light sources 345 may not emit light to the portions of the monitoring area 110 associated with the unoccupied segments 500, however, the reflections of light that normally would have originated from interactions with insignificant objects 105, such as walls or furniture, in the monitoring room 110 may be reduced. Such insignificant objects 105 may include objects 105 that the passive-tracking system 115 has deem unworthy of being passively tracked. Accordingly, because of the reduction of these extraneous reflections, the degradations in performance arising from MPP may be avoided. As another benefit, the overall power consumption of the ToF sensor 310 may be decreased from the selective deactivation of the light sources 345. Periodically placing the light sources 345 in a deactivated state, where they otherwise would not be, may also extend their operational lifetimes.

The imaging sensor 370 may forward the data it generates from the received reflections to the main processor 320, which may determine positional information associated with the human object 105. As an example, the processor 320 may determine at least a depth distance for the human object 105 with respect to the ToF sensor 310, which can enable the processor 320 to provide Z coordinates for the human object 105. (The data from the sensor 370 may also enable the processor to determine X and Y coordinates for the human object 105.) This positional information may be used to complete a full set of positional coordinates associated with the human object 105 in which at least some of the set originates from other sensors of the passive-tracking system 115. Such information may also be used to confirm coordinates that are realized from the other sensors.

In some cases, the tracking data associated with the human object 105 may only include data related to the X and Y coordinates of the human object 105. In such a scenario, the main processor 320 may generate an estimated Z coordinate for purposes of determining the location of the human object 105. As an example, the Z coordinate may be based on previous Z coordinates realized from tracking data associated with other human objects 105 in the monitoring area 110, with, for example, more weight given to locations typically occupied by humans in the monitoring area 110. This feature may apply to other coordinates that may not be available, such as in the case of the tracking data only including data related to the X and Z coordinates, the Y and Z coordinates, or even a single coordinate.

As another option, if the sensors of the passive-tracking system 115 are co-located (or not remote from one another), the use of only X and Y coordinates from the tracking data may be suitable, thereby obviating the need for a Z coordinate. If the segments 500 are 2D, then the main processor 320 may also only need to determine two positional coordinates (such as the X and Y coordinates) of the human object 105 to identify the occupied segments 500. As such, the location of an object 105 may be based on either two or three positional coordinates. Optionally, the location may be based on a single coordinate or one or more ranges of coordinates. For example, the positional data of an object 105 may include a range of X, Y, and/or Z coordinates.

As shown above, the selective activation and deactivation of the light sources 345 may be based (either completely or partially) on the tracking data provided by the tracking data generated by one or more sensors of the passive-tracking system 115, other than the ToF sensor 310. Examples of such sensors include the visible-light sensor 300, the thermal sensor 315, and the sonar device 355 (or any other combination thereof). Once the initial activation/deactivation of the light sources 345 is executed, the main processor 320 may also rely on the tracking data from these sensors moving forward to control the light sources 345.

As another example, following the initial activation/deactivation of the light sources 345, the processor 320 may rely on tracking data from both the ToF sensor 310 and the other sensor(s) of the passive-tracking system 115 or exclusively from the ToF sensor 310. In the case of the former, the ToF sensor 310 may provide tracking data to obtain a Z coordinate of the human object 105, while the X and Y coordinates may originate from tracking data generated by the other sensors, such as the visible-light sensor 300 and the thermal sensor 315. In addition, some of the tracking data generated by the ToF sensor 310 can be used to confirm or adjust the tracking data from the other sensors. For example, X and Y coordinates may be acquired from the data of the ToF sensor 310, and they may confirm or adjust the X and Y coordinates from the data of the visible-light camera 300 and the thermal sensor 315. In the case of the latter, the X, Y, and Z coordinates (or a subset thereof) may be obtained from the tracking data of the ToF sensor 310 after the initial activation/deactivation of the light sources 345.

In another embodiment, the ToF sensor 310 may operate in a self-sufficiency mode in which it effectively relies only on its own tracking data to activate or deactivate the light sources 345. For example, in an initial operational stage, such as prior to the presence (or detection) of a human object 105 in the monitoring area 110, all the light sources 345 of the ToF sensor 310 may be activated and emitting modulated light in the monitoring area 110. If, for example, a human object 105 enters the monitoring area 110, the light reflected off it may enable the main processor 320 to determine that a potential candidate for passive tracking is currently in the monitoring area 110. In such a case, the processor 320 may identify the occupied segments 500 and deactivate the relevant light sources 345. The processor 320 may also rely on future tracking data exclusively from the ToF sensor 310 to make any necessary adjustments to achieve optimal results.

To be clear, the tracking data relied on to control the light sources 345 may come from any suitable type and combination of sensors, including a single sensor. Moreover, the combination of sensors used to provide the tracking data may be changed at any time. This feature may be useful if a sensor malfunctions or is otherwise providing unreliable data. These principles with respect to tracking data may apply to circumstances where an object 105 being passively tracked moves in the monitoring area 110. Additional material on this topic will be presented below.

In one arrangement, if the tracking data indicates that the human object 105 is no longer in the monitoring area 110, the main processor 320 may signal the controller 400 to return the light sources 345 to normal operation. As an example, normal operation may include returning all the light sources 345 to an activated state or a deactivated state. If all the light sources 345 are returned to an activated state, the ToF sensor 310 may have a faster response time for its part of the passive-tracking process. If they are all returned to a deactivated state, the ToF sensor 310 may reduce its overall power consumption. Of course, the human object 105 returns to or some new object 105 appears in the monitoring area 110, the selective control of the light sources 345 may be reestablished. In another arrangement, if the human object 105 leaves the monitoring area 110, the last state in which the light sources 345 were in may be maintained. This feature may be useful if the human object 105 leaves the monitoring area 110 near a particular part of it that is associated with temporary absences, which may be learned from prior trackings. Examples of such parts of the monitoring area 110 can include closets or restrooms.

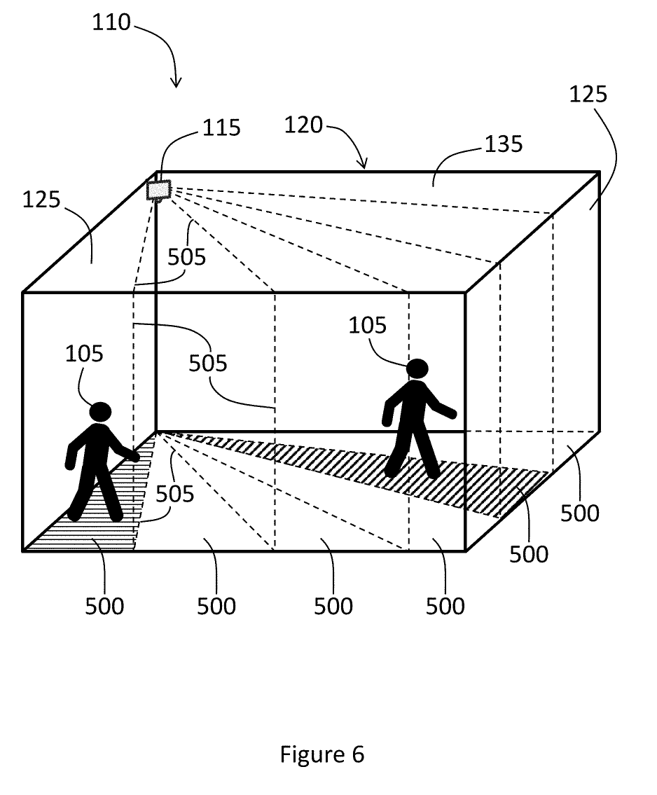

Referring to FIG. 6, the human object 105 may still be present in the monitoring area 110 but has moved to a new location. In addition a new human object 105 has entered the monitoring area 110 (the object 105 closer to the bottom of the drawing). Focusing on the original human object 105, the main processor 320 may determine its new location. In response, the processor 320, in accordance with the description above, may identify the occupied and/or unoccupied segments 500. Depending on the degree of movement, one or more of the previously occupied segments 500 may now be unoccupied segments 500, and one or more of the previously unoccupied segments 500 may be newly occupied segments 500. In addition, some of the segments 500 may remain occupied or unoccupied segments 500. Depending on these changes, the processor 320 may signal the controller 400 to correspondingly activate and deactivate the relevant light sources 345. This process may be repeated as necessary if the original human object 105 continues to move.

As mentioned above, a new human object 105 may have entered the monitoring area 110. The main processor 320 may receive tracking data associated with the new human object 105 and may determine, based on the location of the new human object 105, which of the segments 500 are occupied and/or unoccupied by the new human object 105. In accordance with the processes and examples previously presented, the processor 320 may signal the controller 400 to selectively activate and deactivate the light sources 345. Sometimes, the original human object 105 and the new human object 105 may occupy the same segment(s) 500, although other times, there may be no such overlap between the segments 500. In this example, for a light source 345 to be deactivated, its corresponding segment(s) 500 may not be occupied by either the original human object 105 or the new human object 105. Like the example described above, if the new human object 105 moves in the monitoring area 110, the processor 320 may transition the segments 500 to occupied or unoccupied status and may signal the controller 400 to activate or deactivate the light sources 345 accordingly. This process can be carried out for any number of objects 105 in the monitoring area 110, and depth distances may be determined for all or at least a portion of them.

In one option, if a segment 500 is unoccupied, its associated light source 345 may not necessarily be deactivated. For example, this light source 345 may remain activated, but the intensity of its emitted light may be lowered, such as by a predetermined percentage. The controller 400 may cause the light intensity to be lowered by reducing the level of power supplied to the light source 345. Even though the light source 345 may remain active if its corresponding segment 500 is unoccupied, the amount of extraneous reflections that contribute to MPP may still be significantly decreased. The intensities of light from any of the light sources 345 may also be modified depending on how far away an object 105 is from the ToF sensor 310. For example, intensities may be increased as the object 105 moves away from the ToF sensor 310 and decreased as the object 105 moves closer to it. In yet another option, a light source 345 whose corresponding segment 500 is occupied may still be deactivated. For example, only a small portion of an object 105 may occupy a segment 500, and the level of unwanted reflections produced by the light from the relevant light source 345 may outweigh the benefit of receiving a low number of reflections from the light interacting with the object 105.

In another arrangement, if an object is moving, a range of positions that the object may be able to occupy in the next time interval (such as the next frame) can be estimated. Such an estimate can be based on, for example, predefined maximum motion speeds and possible avenues of movement. The estimated positions can be used to selectively activate and deactivate one or more light sources 345.

Although the examples above show how a monitoring area 110 may be partitioned into a number of segments 500, the description herein may not be so limited. In particular, it may not be necessary to generate or otherwise rely on segments or other partitions to selectively control the light sources 345. For example, information about the positioning of the light sources 345 and the optical elements 410 may be provided to the processor 320. Also, the portion of the monitoring area 110 that is illuminated by the light from a light source 345 may also be available to the processor 320.

Once the main processor 320 acquires the location of an object 105, the processor 320 may determine which of the light sources 345 have orientations that align with the location of the object 105. The processor 320 may also determine which of the light sources 345 have orientations that are out of alignment with the location of the object 105. When referring to an orientation of a light source 345, for purposes of this description, this concept may include the positioning of the light source 345 or the positioning of the light source 345 in combination with other components, such as the optical element 410 with which it is paired. Further, the concept of the orientation of a light source 345 may include the illumination in the monitoring area 110 that is realized when the light source 345 is activated, either solely or in combination with the positioning of the light source 345 and/or the paired optical element 410. Accordingly, one or more various factors, such as the examples presented here, may define, set, determine, or form the orientation of a light source.

Once the location of an object 105 is obtained, the main processor 320 may determine whether any of the light sources 345 have orientations that align with the location of the object 105. The processor 320 may also determine whether any of the light sources 345 have orientations that are out of alignment with the location of the object 105. The processor 320 may then signal the controller 400 to activate the light sources 345 with aligned orientations and to deactivate those with out-of-alignment orientations. To determine whether an orientation for a light source 345 is in or out of alignment with the location, the processor 320 may compare the orientation data with the positional data (of the object 105) and evaluate the possibility that at least a certain portion of the modulated light from the light source 345 may reach the object 105 through a direct path (from the ToF sensor 310 to the object 105). As an example, this evaluation may produce a confidence factor or score that indicates the likelihood that a predetermined percentage of the modulated light may strike the object 105 through the direct path. If the confidence factor meets or is above a predetermined threshold, the orientation for the light source 345 may be considered in alignment with the location. A high confidence factor indicates that a greater portion of the modulated light will hit the object 105, which may reduce the possibility of MPP.

Conversely, if the confidence factor is below the threshold, the orientation may be considered out of alignment with the location. The processor 320 may be configured to continuously update the confidence factor to account for the object 105 moving to a new location or a new object 105 appearing in the monitoring area 110. As such, the light sources 345 may be dynamically activated or deactivated in response to such changes.

When making these determinations, the main processor 320 may consider one or more factors. For example, the type of light source 345 or optical element 410 or the amount of light that typically illuminates the relevant portion of the monitoring area 110 may affect the alignment analysis. Other factors may include the typical interaction of modulated light signals with the portion of the monitoring area 110 or the size or motion of the object 105 being tracked. For example, if the portion of the monitoring area 110 generally produces an excessive amount of extraneous reflected signals, this factor may contribute to a lower confidence factor for alignment. As another example, a smaller object 105 or one that is excessively ambulatory may also lead to a decreased confidence score. Many other factors may be taken into account during this process. Moreover, whatever factors are considered, one or more of them may be weighted for the analysis.

In one embodiment, the main processor 320 may also monitor past performance to make adjustments to its analysis. Past performance may involve a current tracking session or previous ones. For example, the processor 320 may be programmed with any suitable set of algorithms to (artificially) learn from past performance to improve the overall efficiency of the selective control of the light sources 345.

Some of the concepts described here with respect to a system that avoids partitioning the monitoring area 110 into one or more segments 500 may still apply to a system that uses them. For example, the orientation of a light source 345 may be considered in alignment with the location of an object 105 if the object 105 occupies a segment 500 corresponding to the light source 345. The orientation of the light source 345, however, may be considered out of alignment with the location of the object 105 if the object 105 does not occupy a segment 500 corresponding to the light source 345. Moreover, the main processor 320 may generate confidence factors or scores in relation to its determinations that the object 105 occupies (or does not occupy) segments 500. Like the above examples, these confidence factors may indicate the likelihood that a predetermined percentage of the emitted light may strike the object 105 through a direct path. In some cases, a confidence factor may override a finding that the object 105 is occupying a segment 500. For example, the tracking data may show that a small portion of the object 105 occupies a segment 500; however, the processor 320 may generate a relatively low confidence factor and can designate the segment 500 as unoccupied.

In addition to the use of confidence factors, the learning techniques described above may be applicable if segments 500 are employed. For example, the main processor 320 may analyze past performance (for both current and previous tracking sessions) to improve the efficiency of the selective control of the light sources 345.

Although many of the examples of this description list a human as the object 105 in question, the description is not so limited. Other objects 105, including animals and machines, may be passively tracked, and modulated light from the ToF sensor 310 may be controlled with respect to these objects 105. In addition, a number of items that may not be completely integrated with an object 105 may still be considered part of the object 105 for purposes of this description. For example, a human object 105 may be wearing a hat or other article of clothing or may be carrying some other item, like a briefcase. While not physically a part of the human object 105, these items may be considered to be part of the human object 105 and may be passively tracked along with the human object 105. Other examples of this concept may be applicable here. Given the capabilities of the passive-tracking system 115, these items may be distinguished from the actual human object 105.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein.

Furthermore, arrangements described herein may take the form of a computer program product embodied in one or more computer-readable media having computer-readable-program code embodied (e.g., stored) thereon. Any combination of one or more computer-readable media may be utilized. The computer-readable medium may be a computer-readable signal medium or a computer-readable storage medium. The phrase “computer-readable storage medium” is defined as a non-transitory, hardware-based storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable storage medium may be transmitted using any appropriate systems and techniques, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects herein can be embodied in other forms without departing from the spirit or essential attributes thereof. Accordingly, reference should be made to the following claims, rather than to the foregoing specification, as indicating the scope hereof.

What is claimed is:

1. A time-of-flight sensor for reducing multipath propagation, comprising:
a plurality of light sources configured to emit modulated light in a monitoring area, wherein the light sources have predetermined orientations;
a controller communicatively coupled to the light sources, wherein the controller is configured to activate and deactivate the light sources; and
a processor that is communicatively coupled to the controller, wherein the processor is configured to:
receive tracking data from one or more sensors of a passive tracking system, wherein the tracking data identifies a location of a first object in the monitoring area being passively tracked by the passive tracking system;
signal the controller to selectively activate and deactivate the light sources based on the tracking data such that one or more of the light sources with orientations that align with the location of the first object are activated and one or more of the light sources with orientations that are out of alignment with the location of the first object are deactivated.

2. The time-of-flight sensor of claim 1, wherein the plurality of light sources are part of an array of light sources and the predetermined orientations of the light sources are fixed and the processor is further configured to determine a depth distance of the first object with respect to the time-of-flight sensor based on reflections of the modulated light from the first object.

3. The time-of-flight sensor of claim 1, wherein the monitoring area is partitioned into a predetermined number of segments and the predetermined number of segments is equal to the number of light sources such that each light source corresponds to a segment.

4. The time-of-flight sensor of claim 3, wherein the tracking data further indicates that the first object occupies one or more of the segments of the monitoring area and the processor is further configured to signal the controller to selectively activate the light sources based on the tracking data such that one or more of the light sources with orientations that align with the location of the first object are activated by activating the light sources that correspond to the segments occupied by the first object.

5. The time-of-flight sensor of claim 3, wherein the tracking data further indicates that the first object does not occupy one or more of the segments of the monitoring area and the processor is further configured to signal the controller to selectively deactivate the light sources based on the tracking data such that one or more of the light sources with orientations that are out of alignment with the location of the first object are deactivated by deactivating the light sources that correspond to the segments that are not occupied by the first object.

6. The time-of-flight sensor of claim 1, wherein the controller is further configured to activate the light sources by switching the light sources on or by maintaining power to the light sources and to deactivate the light sources by switching the light sources off or by maintaining the light sources in an off state.

7. The time-of-flight sensor of claim 1, further comprising a plurality of optical elements, wherein each optical element is paired with one of the light sources.

8. The time-of-flight sensor of claim 1, wherein the optical elements are diffusers that diffuse the modulated light from the light sources or lenses that project the modulated light from the light sources.

9. The time-of-flight sensor of claim 1, further comprising a shared optical element that is paired with each of the light sources.

10. The time-of-flight sensor of claim 9, wherein the shared optical element is a diffuser that diffuses the modulated light from the light sources or a lens that projects the modulated light from the light sources.

11. The time-of-flight sensor of claim 1, wherein the tracking data also identifies a location of a second object in the monitoring area being passively tracked by the passive tracking system at the same time as the first object and the processor is further configured to signal the controller to selectively activate and deactivate the light sources based on the tracking data such that one or more of the light sources with orientations that align with the locations of both the first and second objects are activated and one or more of the light sources with orientations that are out of alignment with the locations of both the first and second objects are deactivated.

12. The time-of-flight sensor of claim 1, wherein the tracking data also identifies a new location of the first object based on movement by the first object in the monitoring area and the processor is further configured to signal the controller to selectively activate and deactivate the light sources based on the tracking data such that one or more of the light sources with orientations that align with the new location of the first object are activated and one or more of the light sources with orientations that are out of alignment with the new location of the first object are deactivated.

13. A method for reducing multipath propagation, comprising:
determining that a first object is present in a monitoring area;
in response to determining that the first object is present, passively tracking the first object, wherein passively tracking the first object comprises:
determining a location of the first object in the monitoring area; and
controlling a plurality of light sources that emit modulated light in the monitoring area by activating one or more of the light sources that are aligned with the location of the first object and by deactivating one or more of the light sources that are out of alignment with the location of the first object;
receiving reflections of the modulated light from the first object; and
determining a depth distance of the first object based at least in part on the reflections of the modulated light.

14. The method of claim 13, further comprising:
determining a new location of the first object in the monitoring area resulting from movement of the first object; and
controlling the plurality of light sources by activating one or more of the light sources that are aligned with the new location of the first object, wherein at least some of the activated light sources that are aligned with the new location were previously deactivated from being out of alignment with the previous location of the first object.

15. The method of claim 14, further comprising controlling the plurality of light sources by deactivating one or more of the light sources that are out of alignment with the new location of the first object, wherein at least some of the deactivated light sources that are out of alignment with the new location were previously activated from being aligned with the previous location of the first object.

16. The method of claim 13, further comprising:
determining that a second object is present in the monitoring area at the same time as the first object;
in response to determining that the second object is present, passively tracking the first and second objects, wherein passively tracking the first and second objects comprises:
determining a location of the first object and the second object in the monitoring area; and
controlling the plurality of light sources that emit modulated light in the monitoring area by activating one or more of the light sources that are aligned with at least one of the location of the first object or the location of the second object and by deactivating one or more of the light sources that are out of alignment with both the location of the first object and the second object;
receiving reflections of the modulated light from the first and second objects;
determining a depth distance of the first object and the second object based at least in part on the reflections of the modulated light.

17. The method of claim 13, further comprising:
determining the first object is no longer present in the monitoring area and no other objects are present in the monitoring area; and
in response, controlling the plurality of light sources by deactivating all the light sources.

18. A method of reducing the effects of multipath propagation arising from the operation of a time-of-flight sensor with a plurality of light sources that emit modulated light in a monitoring area, wherein the monitoring area is partitioned into a plurality of segments and the light sources correspond to the segments, comprising:
receiving tracking data associated with an object in the monitoring area;
analyzing the tracking data to determine which of the segments are occupied by the object;
activating the light sources that correspond to the segments that are occupied by the object;
deactivating the light sources that correspond to the segments that are unoccupied by the object;
emitting modulated light from only the activated light sources;
receiving reflections of the modulated light from the object; and
based on the received reflections, providing a depth distance of the object in the monitoring area with respect to the time-of-flight sensor.

19. The method of claim 18, wherein activating the light sources comprises switching the light sources into an active state or maintaining the light sources in an active state and deactivating the light sources comprises switching the light sources into a deactivated state or maintaining the light sources in a deactivated state.

20. The method of claim 18, wherein each light source corresponds to a single segment of the monitoring area.
